(19) United States
(12) Patent Application Publication
(10) Pub. No.: US 2014/0085871 A1
(43) Pub. Date: Mar. 27, 2014

(54) Illumination Device For A Cap

(71) Applicant: Hsiu-Yu Tsao, Taipei City (TW)

(72) Inventor: Hsiu-Yu Tsao, Taipei City (TW)

(21) Appl. No.: 13/627,726

(22) Filed: Sep. 26, 2012

(51) Int. Cl. F21V 21/084

(52) U.S. Cl. 362/106

(57) ABSTRACT

An illumination device for a cap contains: a cap including a receiving space defined on a front end of a shield portion thereof to retain an illuminating structure. The illuminating structure includes a seat, a control circuit fixed in the seat and having a switch, and at least one emitting element electrically connecting with the control circuit and extending out of a front end of the seat, such that the at least one emitting element is turned on by ways of the switch to emit lights in a night or in a dark place.

### FIELD OF THE INVENTION

The present invention relates to an illumination device for a cap which when wearing the cap and located in the dark place or exercising in the night, the illumination device emits and flashes lights to achieve safety and warning purpose.

### BACKGROUND OF THE INVENTION

A conventional cap is worn to protect a user's head. When the user wears the cap and is located in a dark place or exercises in a night, an illumination device has to be fixed on the forehead to emit lights. However, such an illumination device is complicated and can not be stored and portable easily while it is not in use.

The present invention has arisen to mitigate and/or obviate the afore-described disadvantages.

### SUMMARY OF THE INVENTION

The primary object of the present invention is to provide an illumination device for a cap which when wearing the cap and located in the dark place or exercising in the night, the illumination device emits and flashes lights to achieve safety and warning purpose.

Another object of the present invention is to provide an illumination device for a cap which is stored and portable conveniently.

To obtain the above objective, an illumination device for a cap provided by the present invention contains:

a cap including a receiving space defined on a front end of a shield portion thereof to retain an illuminating structure;

the illuminating structure including a seat, a control circuit fixed in the seat and having a switch, and at least one emitting element electrically connecting with the control circuit and extending out of a front end of the seat, such that the at least one emitting element is turned on by ways of the switch to emit lights in a night or in a dark place.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view showing the exploded components of an illumination device for a cap according to a preferred embodiment of the present invention.

FIG. 2 is another perspective view showing the exploded components of the illumination device for the cap according to the preferred embodiment of the present invention.

FIG. 3 is a plan view showing the assembly of the illumination device for the cap according to the preferred embodiment of the present invention.

FIG. 4 is a perspective view showing the operation of the illumination device for the cap according to the preferred embodiment of the present invention.

### DETAILED DESCRIPTION OF THE PREFERRED EMBODIMENTS

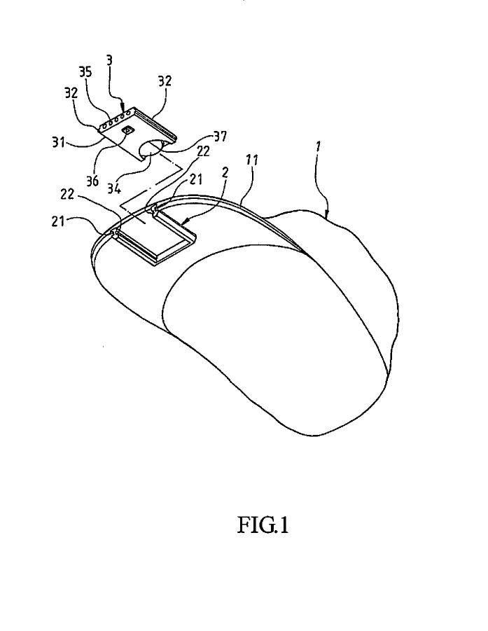

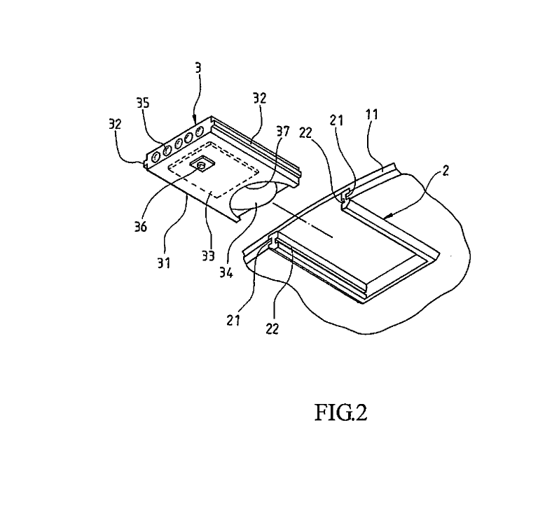

FIGS. 1 and 2 are a perspective view showing the exploded components of an illumination device for a cap according to a preferred embodiment of the present invention. An illumination device of the present invention comprises: a cap 1 and an illuminating structure 3 retained on the cap 1, wherein the cap 1 includes a receiving space 2 defined on a front end of a shield portion 11 thereof. In this embodiment, the receiving space 2 has a positioning slot 21 defined on an outer rim thereof to retain the shield portion 11 and has two symmetrical recesses 22 defined on two inner sides thereof.

The illuminating structure 3 includes a seat 31, two rails 32 disposed on two sides of the seat 31 and corresponding to the two recesses 22 of the receiving space 2, a control circuit 33 and at least one cell 34, both of which are fixed in the seat 31, at least one emitting element 35 electrically connecting with the control circuit 33 and extending out of a front end of the seat 31, a switch 36 mounted in the control circuit 33 and extending out of a bottom end of the seat 31, and a semi-circular cutout 37 formed on a rear end of the seat 31 so that the at least one cell 34 extends out of the cutout 37 to be replaced easily. In this embodiment, the at least one emitting element 35 is a light emitting diode (LED) with a color or different colors.

In operation, the two rails 32 of the illuminating structure 3 are slid into the two recesses 22 of the receiving space 2 to position the illuminating structure 3. When wearing the cap 1, the at least one emitting element 35 is turned on by ways of the switch 36 to emit lights in the night or in a dark place, thus obtaining a safety and warning purpose.

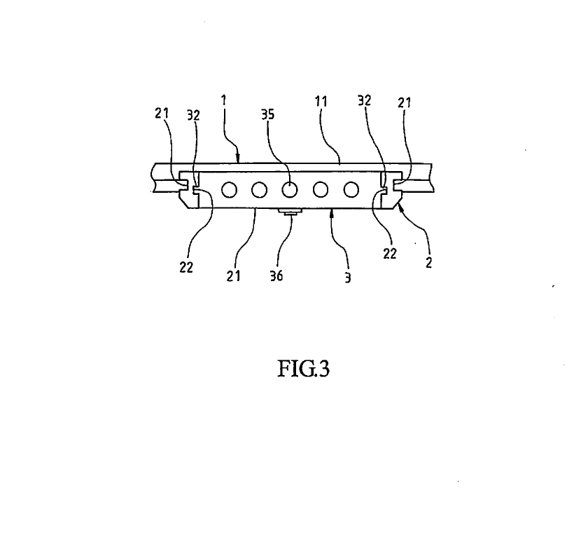

FIG. 3 is a plan view showing the assembly of the illumination device for the cap according to the preferred embodiment of the present invention. The illuminating structure 3 is fixed by sliding the two rails 32 into the two recesses 22 of the receiving space 2, such that the at least one emitting element 35 is fixed on a front end of the illuminating structure 3 to make illumination.

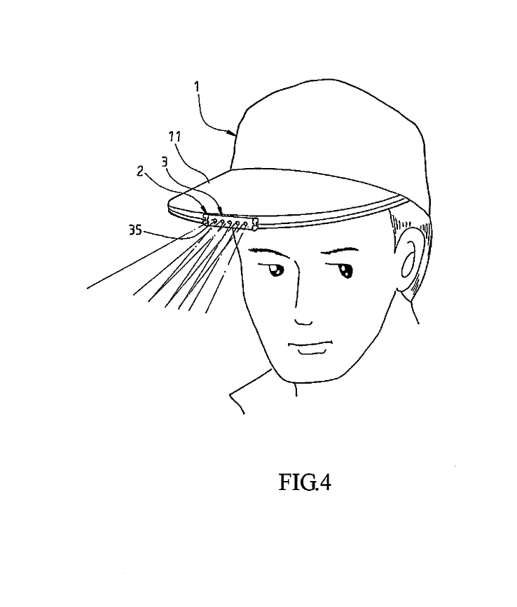

FIG. 4 is a perspective view showing the operation of the illumination device for the cap according to the preferred embodiment of the present invention. As shown in FIGS. 2 and 4, while in use, the cap 1 is worn on a user's head to protect the head. In addition, when the user is located at a dark place or exercises in the night, the switch 36 of the illumination structure 3 is switched on to conduct a power source of the at least one cell 34 with the control circuit 23, thus turning on the at least one emitting element 35 to make illumination. It is to be noted that integrated circuits (IC) allow being fixed in the control circuit to flash the at least one emitting element 35, thus achieving warning purpose. The at least one cell 34 is placed in the cutout 37 of the seat 31 of the illuminating structure 3, hence when the at least cell 34 runs out of power, it is removed from the cutout 37 so as to replace at least one new cell easily. When the cap 1 is not used, since the illuminating structure 3 is retained on the shield portion 11, the cap 1 is flodably stored and is portable easily. Furthermore, the illuminating structure 3 is removed from the receiving space 2 so as to wash the cap 1 independently.

Thereby, the receiving space of the cap matches with the illuminating structure which has the at least one emitting element, the control circuit, and the at least one cell so that the at least one emitting element extends out of the front end of the shield portion, thus assembling the illumination device. When wearing the cap and located in the dark place or exercising in the night, the illumination device emits and flashes lights to achieve safety and warning purpose. Also, the illumination device is stored and portable conveniently.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An illumination device for a cap comprising:
a cap including a receiving space defined on a front end of a shield portion thereof to retain an illuminating structure;
the illuminating structure including a seat, a control circuit fixed in the seat and having a switch, and at least one emitting element electrically connecting with the control circuit and extending out of a front end of the seat, such that the at least one emitting element is turned on by ways of the switch to emit lights in a night or in a dark place.

2. The illumination device for the cap as claimed in claim 1, wherein the receiving space has two symmetrical recesses defined on two inner sides thereof, and the illuminating structure includes two rails disposed on two sides of the seat and corresponding to the two recesses of the receiving space, such that the illuminating structure is retained in the receiving space by sliding the two rails into the two recesses of the receiving space.

3. The illumination device for the cap as claimed in claim 1, wherein the receiving space has a positioning slot defined on an outer rim thereof to retain the shield portion.

4. The illumination device for the cap as claimed in claim 1, wherein the switch extends out of a bottom end of the seat.

5. The illumination device for the cap as claimed in claim 1, wherein a semi-circular cutout is formed on a rear end of the seat so that the at least one cell extends out of the cutout to be replaced easily.

6. The illumination device for the cap as claimed in claim 1, wherein the at least one emitting element is a light emitting diode (LED) with a color or different colors.

7. The illumination device for the cap as claimed in claim 1, wherein the control circuit further includes integrated circuits (IC) fixed therein to flash the at least one emitting element.
